(19) United States
(12) Patent Application Publication
(10) Pub. No.: US 2013/0201033 A1
(43) Pub. Date: Aug. 8, 2013

(54) SENSOR SYSTEMS WIRELESSLY UTILIZING POWER INFRASTRUCTURES AND ASSOCIATED SYSTEMS AND METHODS

(71) Applicants: Gabriel Cohn, Seattle, WA (US); Jagdish Pandey, Seattle, WA (US); Brian Otis, Seattle, WA (US); Shwetak Patel, Seattle, WA (US)

(72) Inventors: Gabriel Cohn, Seattle, WA (US); Jagdish Pandey, Seattle, WA (US); Brian Otis, Seattle, WA (US); Shwetak Patel, Seattle, WA (US)

(21) Appl. No.: 13/816,212

(22) PCT Filed: Aug. 9, 2011
(86) PCT No.: PCT/US11/47133

§ 371 Date: Apr. 17, 2013

Related U.S. Application Data
(60) Provisional application No. 61/372,019, filed on Aug. 9, 2010.

(51) Int. Cl. G08C 17/02

(52) U.S. Cl. CPC G08C 17/02
USPC 340/870.02

(57) ABSTRACT

Systems and methods for a low-power sensor node and network. A low-power sensor node including a battery, a microcontroller, a sensor module, and a transmitter is used to sense an environmental condition and transmit the information back to a base station via a preexisting power line infrastructure such as power lines of a house or apartment building.

### CROSS-REFERENCE TO RELATED APPLICATION(S)

This application claims priority to pending U.S. Provisional Application No. 61/372,019, filed Aug. 9, 2010, which is incorporated herein by reference in its entirety.

### TECHNICAL FIELD

The present technology is directed generally to sensing systems utilizing power infrastructures. In particular, several embodiments of the present technology are directed to low-power sensor node(s) and a base station that form a sensor network utilizing preexisting power line installations as a wireless antenna for sensor nodes communicating with a base station.

### BACKGROUND

There have been many attempts to achieve building-wide sensing and monitoring of environmental conditions such as heat, humidity, light, and other measurable conditions. Despite rapid advances in computing power and technology, there has not been a successful product that enables a home owner or building manager to monitor various conditions within a building outside of such devices as thermostats. Many conventional sensing systems are too expensive or require too much expertise or supervision to reach widespread appeal. For example, among the many barriers to this type of system is the battery life of sensors. It is impractical for many consumers to replace dozens of batteries even as infrequently as once every one or two years. Accordingly, most homeowners and building managers do not employ any sort of building-wide sensor system and, accordingly, are often unaware of many potentially dangerous conditions in their homes or buildings. Humidity, vapor presence, unnecessary light usage, and rodent and insect infestations are all examples of expensive and potentially dangerous conditions that may be detected with a proper sensing mechanism. In many instances, however, such conditions are not monitored because of the above-mentioned constraints and shortcomings of conventional sensing systems.

### BRIEF DESCRIPTION OF THE DRAWINGS

FIG. 1 is a partially schematic view of a sensing system including a sensor node and a base station configured in accordance with several embodiments of the present technology.

FIG. 2 is a top plan view of a building having a sensing system configured in accordance with an embodiment of the present technology.

FIG. 3 is a schematic view of a sensor node configured in accordance with an embodiment of the present technology.

FIG. 4 a partially schematic, isometric view of a sensor node including an antenna configured in accordance with an embodiment of the present technology.

### DETAILED DESCRIPTION

The present technology is directed to sensor systems utilizing power infrastructures and associated systems and methods. In several embodiments, for example, a system can comprise a base station that is operably connected to a preexisting power line installation of a building, and a plurality of sensor nodes. The sensor nodes can include a sensing mechanism, a microcontroller, and a transmitter. The sensor nodes can be configured to wirelessly transmit information gathered by the sensing mechanism to the base station using the preexisting power line installation as a receiving antenna. Electrical signals can be wirelessly delivered to the preexisting power line installation, which carries the signals to the base station, where the information is parsed and delivered to a user in a format that enables the user to respond properly to the monitored condition.

The preexisting power line installation can include the electrical wiring installed in the walls, floor, and/or ceiling of a building. In some embodiments, no change to the preexisting power line installation is required to carry a signal from the sensor nodes, or to plug the base station into an electrical outlet in the building and receive information from the sensor nodes. In some embodiments, the sensor nodes are small, self-contained units (e.g., approximately one inch square and approximately one-half inch thick) that can be placed virtually anywhere in the building. The sensor nodes can be configured to detect various conditions within the building, such as light, moisture, sound, vibration, movement, temperature, static electricity, gas (e.g., carbon monoxide), radiation, or virtually any other measurable environmental condition. In some embodiments, some sensor nodes are created specifically to detect a certain environmental condition. In other embodiments, the sensor nodes are general purpose sensors and are equipped to detect two or more environmental conditions simultaneously or individually as needed.

The disclosure is also directed to a sensor node comprising a sensing mechanism configured to sense an environmental condition at the sensor node, and a transmitter having a transmitting antenna configured to wirelessly transmit data regarding the environmental condition to a receiving antenna using a long-range, near-field transmission. The receiving antenna can be a preexisting electrically conductive structure of a building.

In some embodiments, the sensor node can be carried by a human being. The human body can be operably coupled to the sensor node such that the human body is used as an extension of a transmitting antenna. The sensor node can use the electrical properties of the human body to transmit a signal to a preexisting power line installation as is described herein. In these embodiments, the environmental condition that the sensor node is equipped to monitor can include characteristics of the human body. For example, the sensor node can measure heart rate, blood pressure, temperature, and any other suitable characteristic of a human body. In these embodiments, the power source for the sensor node can include thermal, chemical, or kinetic energy gathered from the human body. In addition to human subjects, the sensor nodes can be carried by any living organism, such as pets or even plants.

In still further embodiments, the disclosure is directed to a method for monitoring environmental conditions of a house, a building, or any other structure. The method can include sensing an environmental condition with a sensing mechanism at a sensor node and transmitting information representing the environmental condition wirelessly through a preexisting electrical power line installation to a base station connected to the preexisting electrical power line installation. In some embodiments, the base station and sensor nodes can communicate wirelessly and bidirectionally. The sensor node is configured to operate using very little power. In some embodiments, for example, the sensor node operates on less than approximately 1 mW while transmitting, and as little as approximately 2 μW while not transmitting.

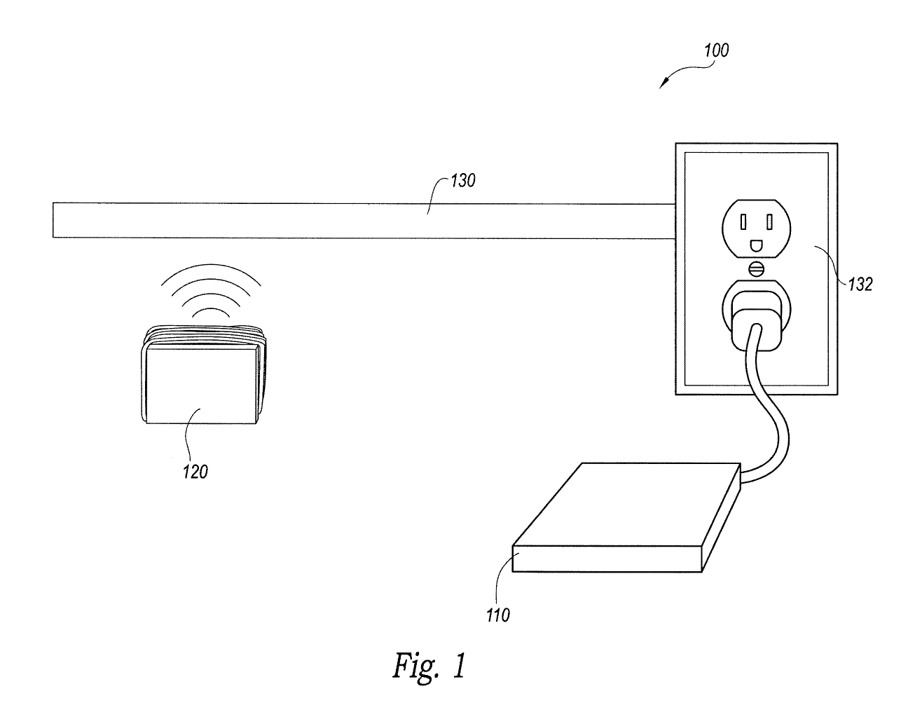

Certain specific details are set forth in the following description and in FIGS. 1-4 to provide a thorough understanding of various embodiments of the technology. Other details describing well-known structures and systems often associated with sensors and power line systems have not been set forth in the following disclosure to avoid unnecessarily obscuring the description of the various embodiments of the technology. Many of the details, dimensions, angles, and other features shown in the Figures are merely illustrative of particular embodiments of the technology. Accordingly, other embodiments can have other details, dimensions, angles, and features without departing from the spirit or scope of the present technology. A person of ordinary skill in the art, therefore, will accordingly understand that the technology may have other embodiments with additional elements, or the technology may have other embodiments without several of the features shown and described below with reference to FIGS. 1-4.

FIG. 1 is a partially schematic view of a sensing system 100 configured in accordance with several embodiments of the present disclosure. The sensing system 100 includes a base station 110 and one or more sensor nodes 120 (only a single sensor node 120 is shown in the illustrated embodiment). The base station 110 is electrically connected to a power line 130, such as an electrical line in a house or building. In some embodiments, for example, the base station 110 can be plugged into a conventional power outlet 132. In other embodiments, however, the base station 110 may be electrically connected to the power line 130 using a different arrangement and/or be powered using other suitable techniques. The power line 130 can be generally defined as any suitable electrically conductive structure capable of carrying an electrical signal. For example, the power line 130 can include electrically conductive plumbing such as copper pipes, electrical structures in a building such as rebar, or other structural components. The power line 130 can also include appliances such as dishwashers, televisions, lamps, or other appliances that are electrically connected to electrical structures in the building.

The sensor nodes 120 can be positioned throughout a house, building, or other structure where they can successfully transmit data to the power line 130. For example, the sensor nodes 120 can be positioned near walls having installed power lines 130, or near electrically conductive plumbing, or near any other electrically conductive structure to reduce the distance over which the sensor nodes 120 must transmit a signal. The distance between the sensor nodes 120 and the nearest power line 130 can be relatively large, but due to the long wavelength of the receiving antenna (approximately 11 meters), the transmission is still considered to be a near-field transmission. The sensor nodes 120 are generally positioned where they can detect an environmental condition. For example, if sensor nodes are employed to detect humidity, one or more sensor nodes 120 can be positioned in a basement or other place where humidity is likely to accumulate. In other embodiments, the sensor nodes 120 can be carried by a human or other living organism, and can be configured to detect a biological characteristic of the living organism. The sensor nodes 120 can gather data regarding the environmental condition and relay the data wirelessly to the power line 130, and the power line 130 can carry the signal back to the base station 110. In some embodiments, the base station 110 can transmit a signal back to the sensor node 120.

One feature of the sensing system 100 is that, in contrast with conventional designs in which individual sensors must transmit a signal all the way from the sensor to a base station, the sensing system 100 can relay data simply by transmitting data from the sensor node 120 to the nearest power line 130. In some embodiments, for example, one or more sensor nodes 120 are plugged directly into a conventional power outlet or are used to monitor a condition surrounding an appliance that is plugged into a conventional power outlet. The distance from the sensor node 120 to the power line 130 is accordingly extremely short. In this way, the sensor node(s) 120 can operate with significantly less power due to the shorter transmission distance. For example, in some embodiments individual sensor nodes 120 may consume approximately 1 mW or less (e.g., 950 μW) during operation.

In some embodiments, the sensor nodes 120 can transmit data to the power line 130 at a relatively low frequency, such as approximately 27, 40, or 44 Mhz. The sensing system can be used on virtually any suitable frequency, although many frequencies may be occupied or otherwise inaccessible due to local regulations. By some measurements, this transmission frequency may be considered inefficient. However, existing power lines 130, such as electrical installations and the like, are comparatively large and therefore are very efficient receiving antennas. The resulting wireless transmission is accordingly a long-range, near-field transmission. The sensor nodes 120 can be positioned within a house or building where the power line 130 of the building generally surrounds individual sensor nodes 120. The wireless transmission is “long-range” because, in at least some aspects, the distance from the sensor node 120 to the base station 110 is large compared to the dimensions of the sensor node 120. The wireless transmission is “near-field” because the distance between the sensor node 120 and the power line 130, which is the receiving antenna, is generally smaller than approximately 1.5 times the wavelength of the receiving antenna (e.g., at 27 Mhz, the wavelength is approximately 11 meters). In other embodiments, however, the sensor nodes 120 can transmit data using different frequencies.

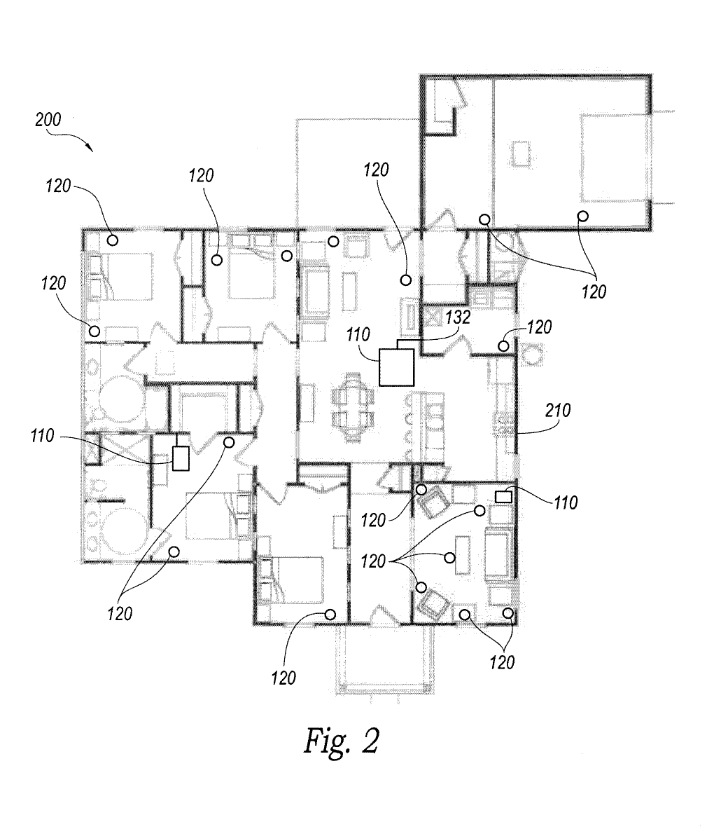

FIG. 2 is a top plan view of the sensing system 100 of FIG. 1 deployed in a sample building 200 having a preexisting power line 130 installed therein in accordance with an embodiment of the present technology. Several sensor nodes 120 can be positioned as desired throughout the building 200 and can be deployed to detect various environmental conditions. One or more base stations 110 can be deployed around the building 200 to gather data from the sensor nodes 120. In some embodiments, for example, the base station(s) 110 can be positioned centrally in the building 200 to reduce the overall distance between any given sensor node 120 and the nearest base station 110. In other embodiments, however, the base station(s) 110 may have a different arrangement relative to the sensor node(s) 120 and/or building 200.

The dimensions of the building 200 and the power line 130 installation can govern the placement of the sensor nodes 120 and the base station(s) 110. For example, a small, square building may have a single, centrally located base station, whereas a floor plan with a more complex shape may have two or more base stations to communicate effectively with the distributed sensor nodes 120. The base stations 110 can draw power from the electrical outlet 132 and can accordingly power a larger transmission mechanism that can transmit data to a computer over Bluetooth, Wi-Fi, or other suitable wireless data communication means. In some embodiments, the base station(s) 110 can include sufficient computing power to process the data and may issue an alert if one of the sensor nodes 120 reports a condition that requires attention.

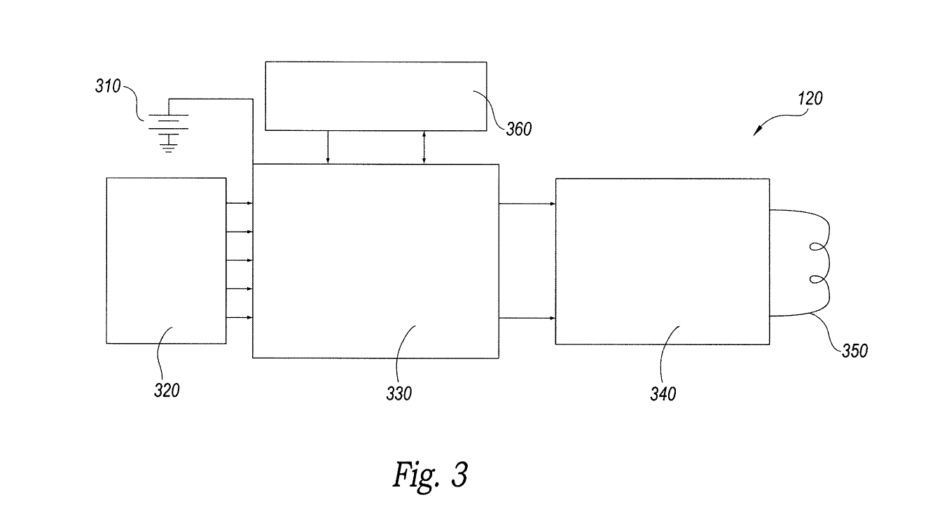

FIG. 3 is a schematic view of the components of an individual sensor node 120 configured in accordance with an embodiment of the present technology. The sensor node 120 can include, for example, a power source 310, a sensing mechanism 320, a microcontroller 330, a transmitter 340, an antenna 350, and a programming interface 360. The power source 310 can be a battery (e.g., a 3.0 V 225 mAh lithium cell battery), a solar cell, or other suitable power source. As described herein, in some embodiments the power requirements for individual sensor nodes 120 can be approximately 1 mW. Accordingly, the power source 310 can provide sufficient power to operate the sensor node 120 for extremely long periods of time. In embodiments in which the power source 310 is a battery, for example, it is expected that the power source 310 can outlast a theoretical shelf-life of the battery (e.g., approximately 10 years). One feature of the extremely low power requirements for the sensor nodes 120 is low cost of ownership for operators of the sensing system 100—the sensor nodes 120 can last for an extremely long time without any need for changing or charging the power source 310. Further, when the power source 310 is drained, the sensor node 120 itself can be entirely replaced. This feature is expected to significantly reduce the operating costs of the sensing system 100 as compared to conventional systems that require significant maintenance costs due to battery replacement, etc.

The sensing mechanism 320 can be any suitable sensor that is known in the art, for example, a simple optical sensor for detecting the presence or absence of light, a thermistor for detecting temperature, a MEMS device, or other suitable sensing mechanisms. The sensing mechanism 320 can deliver a signal representing the sensed data to the microcontroller 330. The microcontroller 330 can be an ultra low-power MCU (e.g., such as a TI MSP 430) or another suitable microcontroller. In some embodiments, the microcontroller 330 can be configured to control timing for the sensor node 120, manage power to the sensing mechanism 320 and to the transmitter 340, and modulate the transmitter 340. In other embodiments, however, the microcontroller 330 may have a different arrangement.

The sensing mechanism 320 and/or the microcontroller 330 can passively monitor an environmental condition with transmitting components of the sensor node 120 switched off. For example, the transmitter 340 and the antenna 350 can be switched off unless the monitored environmental condition reaches a predetermined threshold level, at which point the sensing mechanism 320 and/or the microcontroller 330 can initiate a transmission. By way of example, if the sensor node 120 is used to monitor a temperature in a refrigerator, the sensor node 120 will transmit no data until the temperature in the refrigerator reaches a level at which the contents of the refrigerator may be at risk. The sensor node 120 can initiate a transmission to the base station 110, reporting the increased temperature by switching on the transmitter 340 and the antenna 350 when needed. In other embodiments, the sensor node 120 can operate according to a predetermined schedule. This feature is expected to further reduce the overall power consumption of the sensor node(s) 120 of the system 100. In some embodiments, the sensing mechanism 320 of the sensor node 120 can initiate the transmission and, accordingly, the sensor node 120 can operate without a microcontroller 330.

In one embodiment, the transmitter 340 can be a frequency shift keying (“FSK”) transmitter using a Pierce oscillator to transmit data using the antenna 350. In some embodiments, the transmitter 340 can transmit data using a capacitor to effect a 10 kHz shift in frequency to represent bits in a data string. For example, the transmitter 340 can include a 4 pF capacitor to shift the frequency from 26.999 MHz (representing a “1”) and 27,009 MHz (representing a “0”). In other embodiments, the data is transmitted in a different format. In some embodiments, the transmitter 340 can include a buffer (not shown) to amplify the transmission signal to reach greater distances. The sensor node 120 can also include a receiver (not shown) configured to receive data from the base station 110. The receiver can be built into the transmitter 340. In other embodiments, the transmitter 340 can have a different arrangement and/or include different features.

In some embodiments, the transmitter 340 can perform “frequency hopping” to find a frequency that works for a given installation. For example, the sensor nodes 120 can begin transmitting at around 27 MHz, but if the signal does not have sufficient clarity, the transmitter 340 can “hop” to a different frequency higher or lower until a suitable frequency is found. The sensing system 100 can be used with a variety of different building structures and power line 130 layouts and qualities, so each installation is likely to have different electrical properties and carry a signal more clearly on different frequencies. In other embodiments, the sensor nodes 120 can transmit simultaneously on multiple frequencies, and the base station 110 can listen to multiple frequencies and receive the information from one or more of the “best” frequencies. In some embodiments, the base station 110 can also be tuned to find a proper operating frequency. For example, the base station 110 can be impedance-matched to the power line 130 of a given building.

The programming interface 360 can include software components programmed into the microcontroller 330 that enable the sensor node 120 to be configured and managed. The programming interface 360, for example, can enable the sensing mechanism 320 or the microcontroller 330 to be accessed and managed. For example, the programming interface 360 can enable a user to access the timing, the frequency, or the data sampling rate of the sensor node 120. In other embodiments, the programming interface 360 can be configured to enable additional functions/interaction with the system 100.

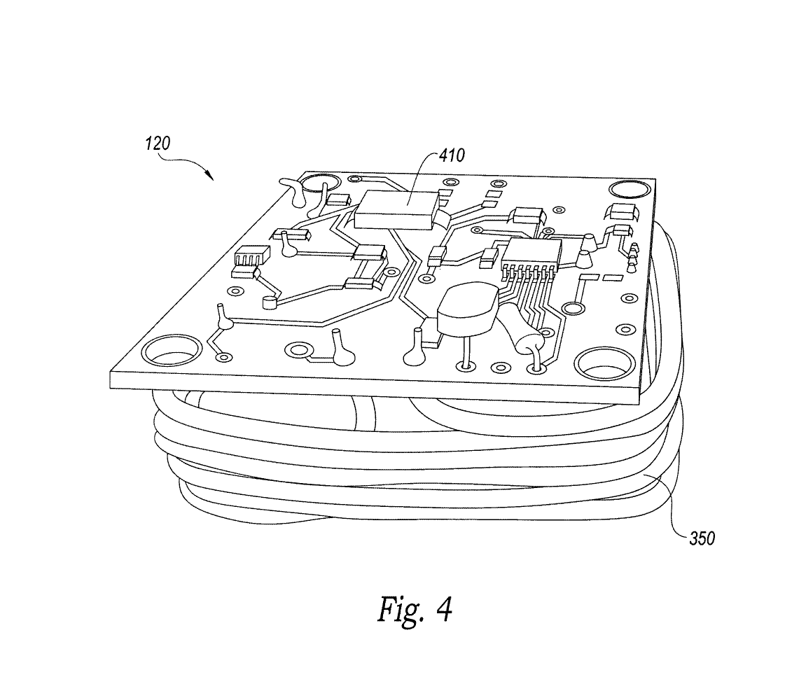

FIG. 4 is a partially schematic, isometric view of an individual sensor node 120 configured in accordance with an embodiment of the present disclosure. The sensor node 120 can include a chip 410 containing, the power source 310, the microcontroller 330, and the transmitter 340 as described above. The sensor node 120 can also include a sensing mechanism 320 and an antenna 350. In the illustrated embodiment, for example, the antenna 350 is formed from a length of wire that surrounds the sensor node 120. For example, the antenna 350 can be made of several turns of 22 gauge wire wrapped around a periphery of the sensor node 120. The antenna 350 can have approximately 350Ω of impedance. In other embodiments, however, the antenna 350 can have a different configuration and/or arrangement relative to the sensor node 120, such as a trace on a printed circuit board.

The following is a description of additional details that can be used in specific embodiments of the present technology. A person of ordinary skill will recognize that other configurations are possible that may be able to achieve a similar result. These embodiments of the technology are provided for purposes of explanation and are not intended to limit the present technology to the specific configurations or arrangements described herein.

In some embodiments, the sensing system 100 can include a fully-programmable wireless platform. Individual sensor nodes 120 can feature an ultra-low-power 16-bit microcontroller 330, a 16-bit ADC (not shown), and a custom 27 MHz frequency-shift-keying (FSK) wireless transmitter 340, which is capable of providing coverage within an entire home and its outside perimeter while consuming less than about 1 mW. In some embodiments, the transmitter 340 consumes approximately 50 μW of the 1 mW, thus rendering its power consumption substantially negligible when compared to the microcontroller 330. In some embodiments, the sensor node 120 measures 3.8 cm by 3.8 cm by 1.4 cm and weighs only 17 grams including the power source 310 and antenna 350. Where the power source 310 is a battery, the sensor node 120 with a simple light sensor beaconing once per minute (or another suitable sensing mechanism 320) can outlive the 10 year shelf-life of a small coin-cell battery.

Although in some embodiments the sensing system 100 is designed for use with a power line 130 for carrying low-frequency AC electrical power at 50-60 Hz, the in-wall residential power line is capable of carrying higher frequency signals when directly coupled to the transmitter 330 and a base station 110. The home power line is also capable of higher data-rate communications, such as data rates up to 200 Mbps.

Traditionally, the wireless transmission component, such as the RF radio component, is the most power intensive component of any wireless sensor node. In some embodiments, the sensor nodes 120 can have a transmitter 340 but no receiver. The sensing system 100 can therefore use a unidirectional communications channel, meaning that each sensor node 120 can only send data. This significant reduction power comes at the cost of communications reliability. Without two-way communication, there is no handshake to ensure that data sent from the node is actually received by the base station. In other embodiments, however, the sensor nodes 120 include a receiver and are capable of two-way communication with the base station 110.

In some embodiments, the transmitter 330 includes a binary frequency shift keying (2-FSK) transmitter using a Pierce oscillator with a 27.0 MHz crystal resonator. To modulate the transmitter, a small pF, on-chip load capacitance across the crystal resonator can be switched to cause a 10 kHz frequency shift. The crystal oscillator has a relatively slow startup time, which varies as a function of the oscillator bias current. When operating in its lowest power setting, the transmitter startup time is less than 4 ms; however, this is reduced to less than 1 ms when the transmitter power is increased.

The oscillator bias current can be set to maintain stable oscillation. A digital buffer chain can isolate the oscillator from the low impedance (e.g., −350Ω) loop antenna. A low power supply voltage (e.g., 0.4V) can be used to power the buffer chain to save power. By adjusting this buffer supply voltage, the output power of the antenna can be varied (e.g., by approximately 18 dB). In one specific example, at the minimum output power the radio consumes only 35 μW (900 μW for the whole node), and at the maximum output power, the transmitter can consume approximately 190 μW (1.5 mW for the whole node). In other embodiments, however, these component values can be varied greatly by varying the values for one or more of the various components.

Without being bound by theory, it is believed that transmitters may be designed to require very low power as long as the stray capacitance is not too large. For example, a discrete transistor implementation on a prototyping board can be used to transmit while keeping the power consumption below several hundred μW. In order to reduce the power further, in some embodiments the oscillator may be implemented on a single silicon die using a 130 μm CMOS process. The die can be wirebonded to a custom printed circuit board (PCB). In one example, the CMOS implementation reduced the power consumption of the transmitter to only 50 μW, while still providing whole-home range.

In some embodiments, the microcontroller 330 can be used to control the operation of the sensor node 120. For example, a Texas Instruments MSP430F2013 16-bit ultra-low-power flash microcontroller, including several low power clocking options, 2 Kbytes of Flash ROM, 128 Bytes of RAM, and a multi-channel 16-bit Sigma-Delta analog to digital converter (ADC) can be used. The microcontroller 330 can be used to control the timing of all signals on the sensor node 120, including powering the sensing mechanism 320 and sampling of sensor data and powering and modulating the transmitter 340. The transmitter 340 can be powered directly from a digital output pin on the microcontroller 330 so that the transmitter 340 can be completely powered down during the sleep phase. In addition, the microcontroller 330 can be used as a general computation platform when the programming interface 360 is exposed. A sensor node's 120 firmware can be easily reprogrammed by connecting a programmer to the Spy-Bi-Wire (2-wire JTAG) interface on the node 120. All ADC input pins can be exposed on the sensor node 120 PCB so that a variety of different sensor connections can be used.

In some embodiments, the operating frequency of the sensing system 100 is approximately 27 MHz, which approximately corresponds to an 11 m wavelength. In order to keep the senor node as small as possible, the antenna 350 can be limited to the size of the sensor node 120, which in some embodiments is approximately 3.8 cm by 3.8 cm. A 350Ω loop antenna consisting of 6 turns of 22 gauge wire wound upon a perimeter of the sensor node 120. Multiple turns can be used to both increase the impedance and to improve the radiation efficiency by increasing the radiation resistance. A relatively heavy gauge wire can be used to reduce the loss resistance of the antenna 350 and to improve the radiation efficiency.

In some embodiments, the sensor nodes 120 can communicate with the base station 110 using the following protocol: a 25-bit packet, including a single start bit, a 7-bit node ID, a 16-bit payload, and a single parity bit. While the transmitter is starting up before the transmission and shutting down after sending the data, it may transmit the “zero” value. The packet structure can be controlled by the firmware on the microcontroller 330, and can therefore be changed for multiple applications, adjusting for the size of the node ID, payload, and error checking. The data can be modulated using NRZ (non-return-to-zero) 2-FSK (binary frequency shift keying). The frequencies used to encode “one” and “zero” can be 26.999 and 27.009 MHz, respectively. In embodiments in which the bandwidth is approximately 10 kHz, the sensor nodes 120 can transmit at a bitrate of 9.6 kbps, which means that substantially the entire 25-bit packet is transmitted in approximately 2.6 ms. Accordingly, it can take less than 4 ms for the crystal oscillator and transmitter to power up, so the total on-time of each transmission is approximately 6.6 ms. Other configurations having a higher bitrate and a lower startup time are possible.

From the foregoing it will be appreciated that although specific embodiments of the technology have been described herein for purposes of illustration, various modifications may be made without deviating from the spirit and scope of the technology. For example, the sensor nodes can operate at a frequency other than 27 MHz (e.g., 44 MHz). Also, in some embodiments the microcontroller can be omitted, or the battery can be larger. Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Thus, the disclosure is not limited except as by the appended claims.

I/we claim:

1. A sensor node, comprising:
a sensing mechanism configured to sense an environmental condition;
an antenna; and
a transmitter configured to wirelessly transmit data regarding the environmental condition from the antenna to a receiving antenna using a long-range, near-field transmission, wherein the receiving antenna comprises a preexisting electrically conductive structure of a building.

2. The sensor node of claim 1, further comprising a microcontroller configured to control at least one of the sensing mechanism and the transmitter.

3. The sensor node of claim 1, further comprising a power source configured to provide power to at least one of the sensing mechanism and the transmitter.

4. The sensor node of claim 1 wherein the power source comprises a battery or an energy harvesting system.

5. The sensor node of claim 1 wherein the long-range, near-field transmission comprises transmission at a frequency of approximately 27 MHz.

6. The sensor node of claim 1 wherein the long-range, near-field transmission comprises transmission at a frequency of approximately 44 MHz.

7. The sensor node of claim 1 wherein the long-range, near-field transmission has a range approximately equal to the size of the building.

8. The sensor node of claim 1 wherein the sensor node consumes approximately 1 mW while transmitting.

9. The sensor node of claim 1 wherein the sensor node consumes less than approximately 2 μW when not transmitting.

10. The sensor node of claim 1 wherein the transmitter consumes approximately 50 μW while transmitting.

11. The sensor node of claim 1, further comprising a receiver on the sensor node configured to receive information from a base station.

12. The sensor node of claim 1 wherein the receiving antenna further comprises at least one of the following: preexisting power lines, preexisting plumbing, or preexisting metal structures of a building.

13. The sensor node of claim 1 wherein the sensor node is configured to be worn by a living being, and wherein the transmitter is configured to use the living being as a transmitting antenna.

14. The sensor node of claim 1 wherein the transmitter comprises a frequency shift keying (FSK) transmitter.

15. The sensor node of claim 1 wherein the transmitter is configured to perform frequency hopping.

16. The sensor node of claim 1 wherein the sensor node is approximately 1 inch square, and the transmitter comprises 22 gauge wire wrapped around a perimeter of the sensor node approximately six times.

17. The sensor node of claim 1, further comprising a buffer configured to amplify a transmission of the sensor node.

18. The sensor node of claim 1, further comprising a base station connected to the receiving antenna, wherein the base station is configured to gather data from the sensor node.

19. The sensor node of claim 15 wherein the base station is impedance-matched to the receiving antenna.

20. A system, comprising:
a base station connected to a preexisting power line installation of a building; and
a sensor node including—
a sensing mechanism;
a microcontroller; and
a transmitter;
wherein the sensor node is configured to wirelessly transmit information gathered by the sensing mechanism to the preexisting power line installation which then relays the information to the base station.

21. The system of claim 20, further comprising a power source configured to provide power to at least one of the sensing mechanism, the microcontroller, and the transmitter.

22. The system of claim 20 wherein the system is configured to consume approximately 1 mW when transmitting, and less than approximately [value?] while not transmitting.

23. The system of claim 20 wherein the transmitter is configured to wirelessly transmit the information through a long-range, near-field transmission.

24. A method, comprising:
sensing an environmental condition with a sensing mechanism at a sensor node; and
transmitting information representing the environmental condition wirelessly to a preexisting electrical power line installation which then relays the information to a base station connected to the preexisting electrical power line installation, wherein the sensor node is configured to operate with less than approximately 1 mW while transmitting.

25. The method of claim 24 wherein transmitting information comprises transmitting information from a transmitter, the method further comprising maintaining the transmitter in an unpowered state until sensing the environmental condition with the sensing mechanism.

26. The method of claim 24 wherein transmitting information comprises transmitting information at approximately 27 MHz.

27. The method of claim 24, further comprising receiving a transmission from the base station.

28. The method of claim 24, further comprising delivering an alert in response to sensing the environmental condition above a predetermined threshold.
